(19) United States
(12) Patent Application Publication
(10) Pub. No.: US 2022/0341296 A1
(43) Pub. Date: Oct. 27, 2022

(54) SAND SCREEN

(71) Applicants: Juan Carlos Flores Perez, The Woodlands, TX (US); Mikhail Gladkikh, Conroe, TX (US); Aaron Avagliano, Tomball, TX (US); Nicholas Barta, Houston, TX (US)

(72) Inventors: Juan Carlos Flores Perez, The Woodlands, TX (US); Mikhail Gladkikh, Conroe, TX (US); Aaron Avagliano, Tomball, TX (US); Nicholas Barta, Houston, TX (US)

(73) Assignee: Baker Hughes Oilfield Operations LLC, Houston, TX (US)

(21) Appl. No.: 17/237,590

(22) Filed: Apr. 22, 2021

(51) Int. Cl. E21B 43/08; E21B 34/08

(52) U.S. Cl. CPC E21B 43/082; E21B 34/08; B33Y 80/00

(57) ABSTRACT

A sand screen including a frame, a filtration media disposed in contact with the frame, the filtration media being of single-piece unitary construction and exhibiting varying flow properties over a surface of the media, or through a radial thickness of the media. A filtration media being of single-piece unitary construction and exhibiting varying flow properties over a surface area of the media, or through a radial thickness of the media.

### BACKGROUND

In the resource recovery industry and as well in fluid sequestration industry, screens are well known and necessary components of downhole systems to exclude particulate matter from fluid streams such that particulate matter does not end up in places that are undesirable such as production streams or in equipment. Sand screens are complex multilayered devices that require significant time and effort to manufacture and hence are costly. Layered screens also are subject to failure modes and clogging due to inherent spacing between layers of the screen material. The art would well receive less costly and or more efficient screens.

### SUMMARY

An embodiment of a sand screen including a frame, a filtration media disposed in contact with the frame, the filtration media being of single-piece unitary construction and exhibiting varying flow properties over a surface of the media, or through a radial thickness of the media.

An embodiment of a filtration media being of single-piece unitary construction and exhibiting varying flow properties over a surface area of the media, or through a radial thickness of the media.

### BRIEF DESCRIPTION OF THE DRAWINGS

The following descriptions should not be considered limiting in any way. With reference to the accompanying drawings, like elements are numbered alike:

FIG. 1 is a cross sectional view of a media as disclosed herein illustrated on an optional tubular frame and showing a radial change in properties;

FIG. 2 is a view of a media as disclosed herein illustrated on an optional tubular frame and showing a longitudinal change in properties;

FIG. 3 is a view of a media as disclosed herein illustrated on an optional tubular frame and showing additional structures;

FIG. 4 is a view of a media as disclosed herein illustrated on an optional tubular frame and showing a circumferential change in properties;

FIG. 5 is a perspective view of another embodiment using a different frame type; and

FIG. 6 is a schematic view of a wellbore system including the single-piece unitary media as disclosed herein.

### DETAILED DESCRIPTION

A detailed description of one or more embodiments of the disclosed apparatus and method are presented herein by way of exemplification and not limitation with reference to the Figures.

The sand screen as disclosed herein is superior to the prior art in that the properties of the filtration media are adjustable during manufacture to match the properties of the formation. Specifically, the media may vary in flow properties along the media length, around the media circumference, or through a radial thickness of the media. The media may also be configured to reduce the skin and/or modify the permeability front face with the formation to achieve a minimum resistance or disturbance to flow.

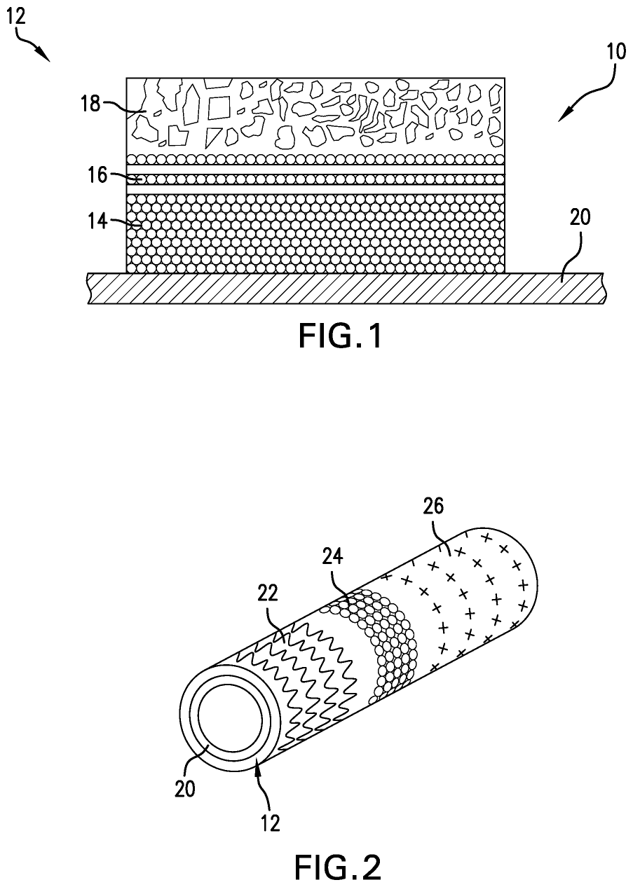

Referring to FIG. 1, a cross section view of a sand screen 10 as disclosed herein is illustrated. The screen 10 comprises a filtration media 12 of a single-piece unitary construction and having differing properties over a surface area of the media, that area being along a longitudinal length or around the media circumference, or through a radial thickness of the media. As illustrated in FIG. 1, changing properties in the radial direction are shown using differing pictoral representation. These differences are in layers for FIG. 1 and numbers 14, 16 and 18. Optionally, this media 12 may also be disposed about a tubular 20 (with the tubular being a separate structure upon which the media 12 is disposed or may be a part of the single-piece unitary structure of the media 12. The tubular 20 is broadly referred to as a frame herein. The media 12 may be employed alone without a frame. Since the media is a single-piece unitary construction, it is possible to provide threads at ends thereof to be connected with a string (not shown) as would be the tubular 20 but not actually use a tubular 20 at all. It is to be appreciated that the illustration is only for example. There may be more or fewer layers in the media 12 and they may be consistent properties for that layer or properties may also change within that layer. Distinguishing is that the entire media 12 is of a single-piece unitary structure so the “layers” are not actually separate entities but rather are simply differing property areas or volumes within the single-piece unitary structure. Another embodiment is illustrated in FIG. 2 where there is difference in properties over a longitudinal length of the media 12. These are labeled 22, 24 and 26 and again use differing pictoral representation to provide understanding of the embodiment. This embodiment may also be combined with that of FIG. 1 to have properties vary both radially and longitudinally. Properties contemplated are those that treat fluids having different viscosities or densities, or both differently. For example, a fluid having a first viscosity might be excluded while a fluid having another viscosity might be promoted. The properties of the screen that are selected are thus a function of the dynamic properties of fluids that are either desired or not desired.

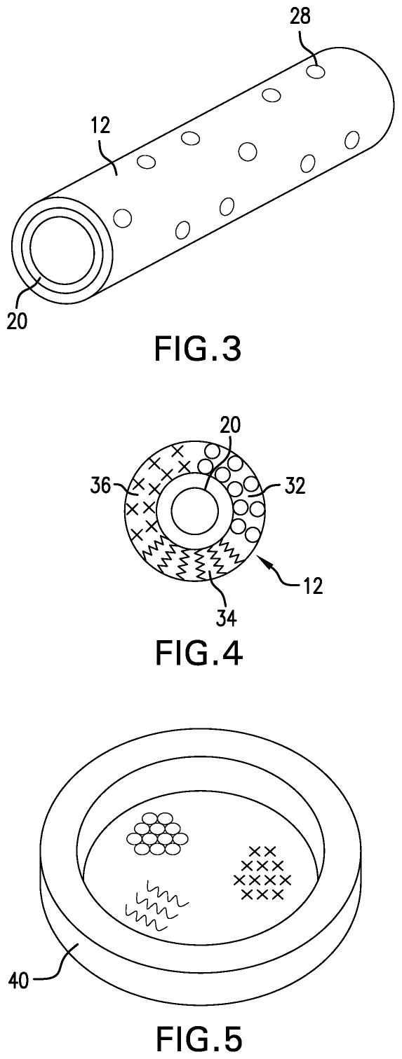

FIG. 3 depicts another value of the single-piece unitary construction with varying properties as disclosed herein. The depiction is of discrete structures 28 in the media 12. These structures may be support structures that defend against compression of the media 12 that are formed as a part of the single-piece unitary structure of the media 12 or may be structures related to flow such as inflow control devices that are formed as a part of the single-piece unitary structure of the media 12. These structures also may be combined with any of the embodiments shown in other figures hereof

Referring to FIG. 4, differing properties around a circumference of the media 12 is illustrated again with the pictoral indicators and identified by numerals 30, 32 and 34. Again, combination with the other embodiments is contemplated.

Referring to FIG. 5, another embodiment is illustrated that uses a frame 40 instead of a tubular type frame 20. Frame 40 is a plug type frame that is configured to be screwed or pressed or welded, etc. into a tubular for a string (not shown). Within the frame 40 is a media 12 having the same possible configurations noted for the other embodiments. Further, the frame 40 may also comprise a part of the single-piece unitary construction, if desired.

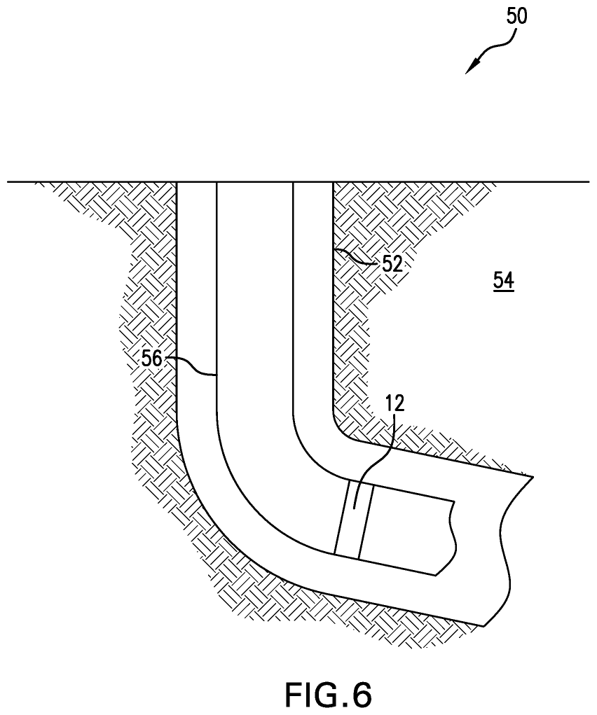

Referring to FIG. 6, a wellbore system 50 is illustrated. The system 50 includes a borehole 52 in a subsurface formation 54 having a string 56 therein. The string 56 includes the media 12 therein or thereon.

Properties modifiable in the media 12 include porosity, permeability, surface tension, hydrophobicity, oleophilicity, hydrophilicity; oleophobicity, etc.

Manufacture of the media 12 as disclosed herein is most efficiently done using an additive manufacturing process such as a powder bed fusion process including: a Direct Metal Laser Sintering (DMLS); Selective Laser Sintering (SLS); Selective Heat Sintering (SHS); Electron Beam Melting (EBM), or Direct Metal Laser Melting (DMLM); Vat Polymerization using photopolymerization to cure each microfine layer using UV light; Material/binder jetting; or Direct Energy deposition where an electron beam laser mounted on an injection head melts either a wire or filament feedstock or powder material. Materials for use include all common additive manufacturing materials and also shape memory materials. The shape memory material (SMM) may be an alloy or a polymer. Metal SMMs include may be but not limited to nickel titanium alloy, nickel titanium zirconium alloy, titanium nickel copper alloy, copper aluminum manganese alloy, iron nickel cobalt aluminum tantalum boron alloy, copper aluminum niobium alloy, nickel manganese gallium alloy, zirconium copper alloy, polycrystalline iron nickel cobalt aluminum alloy, polycrystalline iron manganese aluminum nickel alloy, polycrystalline nickel titanium zirconium niobium alloy, or combinations including at least one of the foregoing. Activation of the SMMs may be by temperature, electrical exposure, chemical reaction, changes in stress, etc.

Set forth below are some embodiments of the foregoing disclosure:

Embodiment 1: A sand screen including a frame, a filtration media disposed in contact with the frame, the filtration media being of single-piece unitary construction and exhibiting varying flow properties over a surface of the media, or through a radial thickness of the media.

Embodiment 2: The sand screen as in any prior embodiment, wherein the surface is along a longitudinal length of the media.

Embodiment 3: The sand screen as in any prior embodiment, wherein the surface is around a circumference of the media.

Embodiment 4: The sand screen as in any prior embodiment, wherein the frame is also a part of the single piece unitary filtration media.

Embodiment 5: The sand screen as in any prior embodiment, wherein the filtration media includes shape memory materials.

Embodiment 6: The sand screen as in any prior embodiment, wherein the sand screen components are constructed simultaneously in an additive manufacturing process.

Embodiment 7: The sand screen as in any prior embodiment, wherein the filtration media further includes a structure for flow conditioning.

Embodiment 8: The sand screen as in any prior embodiment, wherein the structure is an inflow control configuration.

Embodiment 9: The sand screen as in any prior embodiment, wherein the filtration media further includes a structure for compaction resistance.

Embodiment 10: The sand screen as in any prior embodiment, wherein the varying flow property along the media length is porosity, permeability, or surface tension.

Embodiment 11: The sand screen as in any prior embodiment, wherein the varying flow property around the circumference is porosity, permeability, or surface tension.

Embodiment 12: The sand screen as in any prior embodiment, wherein the varying flow property along the radial thickness is porosity, permeability, or surface tension.

Embodiment 13: A filtration media being of single-piece unitary construction and exhibiting varying flow properties over a surface area of the media, or through a radial thickness of the media.

Embodiment 14: A wellbore system including a borehole in a subsurface formation, a string in the borehole, a filtration media as in any prior embodiment disposed in the string.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of ±8% or 5%, or 2% of a given value.

The teachings of the present disclosure may be used in a variety of well operations. These operations may involve using one or more treatment agents to treat a formation, the fluids resident in a formation, a wellbore, and/or equipment in the wellbore, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A sand screen comprising:
a frame;
a filtration media disposed in contact with the frame, the filtration media being of single-piece unitary construction and exhibiting varying flow properties over a surface of the media, or through a radial thickness of the media.

2. The sand screen as claimed in claim 1 wherein the surface is along a longitudinal length of the media.

3. The sand screen as claimed in claim 1 wherein the surface is around a circumference of the media.

4. The sand screen as claimed in claim 1 wherein the frame is also a part of the single piece unitary filtration media.

5. The sand screen as claimed in claim 1 wherein the filtration media includes shape memory materials.

6. The sand screen as claimed in claim 1 wherein the sand screen components are constructed simultaneously in an additive manufacturing process.

7. The sand screen as claimed in claim 1 wherein the filtration media further includes a structure for flow conditioning.

8. The sand screen as claimed in claim 7 wherein the structure is an inflow control configuration.

9. The sand screen as claimed in claim 1 wherein the filtration media further includes a structure for compaction resistance.

10. The sand screen as claimed in claim 1 wherein the varying flow property along the media length is porosity, permeability, or surface tension.

11. The sand screen as claimed in claim 1 wherein the varying flow property around the circumference is porosity, permeability, or surface tension.

12. The sand screen as claimed in claim 1 wherein the varying flow property along the radial thickness is porosity, permeability, or surface tension.

13. A filtration media being of single-piece unitary construction and exhibiting varying flow properties over a surface area of the media, or through a radial thickness of the media.

14. A wellbore system comprising:
a borehole in a subsurface formation;
a string in the borehole;
a filtration media as claimed in claim 13 disposed in the string.
